(19) United States
(12) Patent Application Publication
(10) Pub. No.: US 2026/0063430 A1
(43) Pub. Date: Mar. 5, 2026

(54) INFORMATION PROCESSING SYSTEM, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Natsumi ITO, Shiojiri (JP); Makiko ODAI, Matsumoto (JP)

(21) Appl. No.: 19/311,037

(22) Filed: Aug. 27, 2025

(30) Foreign Application Priority Data
Aug. 29, 2024 (JP) 2024-147340

(51) Int. Cl. G01C 21/34; A63F 9/18; H04N 1/00

(52) U.S. Cl. CPC G01C 21/343; H04N 1/00172; H04N 1/00485; A63F 9/18; H04N 2201/0094

(57) ABSTRACT

An information processing system according to the present disclosure includes a storage unit, an input unit, and a control unit. The storage unit stores a representative image and a local image for each of a plurality of tour points. The representative image is a representatively-acquired image showing a corresponding tour point of the plurality of tour points. The local image shows a locally-acquired image at the corresponding tour point of the plurality of tour points. The input unit inputs information including designation information indicating a destination point of a tour designated by a participant of the tour. The control unit determines a relay point based on the destination point, and determines a tour route based on the destination point and the relay point.

The present application is based on, and claims priority from JP Application Serial Number 2024-147340, filed Aug. 29, 2024, the disclosure of which is hereby incorporated by reference herein in its entirety.

### BACKGROUND

### 1. Technical Field

The present disclosure relates to an information processing system, an information processing method, and a non-transitory computer-readable storage medium storing a program.

### 2. Related Art

WO 2017/164096 discloses a sightseeing assistant device related to a tour event. The sightseeing assistant device evaluates tour routes including sightseeing spots on the basis of the times required for sightseeing and evaluation values of the sightseeing spots and the travel times between the sightseeing spots, and selects a tour route on the basis of the evaluation results.

However, in the technique described in WO 2017/164096, a tour route is selected from predetermined tour routes. Therefore, in the technique described in WO 2017/164096, there is a high possibility that the same tour route will be selected for participants who participate more than once, causing the participants to lose interest. As such, the technique has room for improvement with respect to the continued holding of tour events.

Accordingly, there is a demand for the development of a technique that enables the continued holding of tour events to visit tour points without causing the participants to lose interest.

### SUMMARY

The information processing system according to an aspect of the present disclosure includes a storage unit configured to store a representative image and a local image for each of a plurality of tour points, the representative image being a representatively-acquired image showing a corresponding tour point of the plurality of tour points, the local image showing a locally-acquired image at the corresponding tour point of the plurality of tour points; an input unit configured to input information including designation information indicating a destination point of a tour of the plurality of tour points, the destination point being designated by a participant of the tour; and a control unit configured to determine a tour route of the participant and output a card related to a point included in the tour route to an output destination. The control unit is further configured to determine a relay point based on the destination point designated by the designation information; determine the tour route based on the destination point and the relay point; when the input unit inputs point information indicating arrival of the participant at a processing target point, output, as the card, a first card related to a next tour point following the processing target point along the tour route to an output destination, the processing target point being any one of a starting point and the relay point of the tour route, the first card including the representative image of the processing target point or the representative image of the next tour point; and when the input unit inputs point information indicating arrival of the participant at the destination point, output, as the card, a second card related to the destination point to an output destination.

The information processing method according to an aspect of the present disclosure is a method of information processing executed by a computer. The information processing includes storing a representative image and a local image for each of a plurality of tour points, the representative image being a representatively-acquired image showing a corresponding tour point of the plurality of tour points, the local image showing a locally-acquired image at the corresponding tour point of the plurality of tour points; inputting information including designation information indicating a destination point of a tour of the plurality of tour points, the destination point being designated by a participant of the tour; and performing an output process of determining a tour route of the participant and outputting a card related to a point included in the tour route to an output destination. The output process includes determining a relay point based on the destination point designated by the designation information; determining the tour route based on the destination point and the relay point; when point information indicating arrival of the participant at a processing target point is input, outputting, as the card, a first card related to a next tour point following the processing target point along the tour route to an output destination, the processing target point being any one of a starting point and the relay point of the tour route, the first card including the representative image of the processing target point or the representative image of the next tour point; and when point information indicating arrival of the participant at the destination point is input, outputting, as the card, a second card related to the destination point to an output destination.

The non-transitory computer-readable storage medium according to an aspect of the present disclosure stores a program for causing a computer to execute information processing. The information processing includes storing a representative image and a local image for each of a plurality of tour points, the representative image being a representatively-acquired image showing a corresponding tour point of the plurality of tour points, the local image showing a locally-acquired image at the corresponding tour point of the plurality of tour points; inputting information including designation information indicating a destination point of a tour of the plurality of tour points, the destination point being designated by a participant of the tour; and performing an output process of determining a tour route of the participant and outputting a card related to a point included in the tour route to an output destination. The output process includes determining a relay point based on the destination point designated by the designation information; determining the tour route based on the destination point and the relay point; when point information indicating arrival of the participant at a processing target point is input, outputting, as the card, a first card related to a next tour point following the processing target point along the tour route to an output destination, the processing target point being any one of a starting point and the relay point of the tour route, the first card including the representative image of the processing target point or the representative image of the next tour point; and when point information indicating arrival of the participant at the destination point is input, outputting, as the card, a second card related to the destination point to an output destination.

### BRIEF DESCRIPTION OF THE DRAWINGS

FIG. 1 is a block diagram illustrating a configuration example of an information processing system according to an embodiment.

FIG. 2 is a diagram illustrating an example of information registered in a storage unit of the information processing system of FIG. 1.

FIG. 3 is a flowchart for explaining an example of information processing in the information processing system of FIG. 1.

FIG. 4 is a flowchart continued from FIG. 3.

FIG. 5 is a schematic diagram illustrating an example of a sightseeing route determined in the information processing example of FIG. 3.

FIG. 6 is a schematic diagram illustrating an example of a card output at a starting point in the information processing example of FIG. 3 and FIG. 4.

FIG. 7 is a schematic diagram illustrating an example of the back side of the card of FIG. 6 or a second card.

FIG. 8 is a schematic diagram illustrating an example of a card output at a relay point in the information processing example of FIG. 3 and FIG. 4.

FIG. 9 is a schematic diagram illustrating an example of another card output at the relay point in the information processing example of FIG. 3 and FIG. 4.

FIG. 10 is a schematic diagram illustrating an example of the back side of the card of FIG. 9 or a second card.

FIG. 11 is a schematic diagram illustrating an example of a card output at a destination point in the information processing example of FIG. 3 and FIG. 4.

FIG. 12 is a schematic diagram illustrating an example of the back side of the card of FIG. 11 or a second card.

FIG. 13 is a diagram illustrating an example of a hardware configuration of an apparatus.

### DESCRIPTION OF EMBODIMENTS

Hereinafter, an embodiment of the present disclosure will be described with reference to the drawings. The drawings are merely examples for explaining the embodiment of the present disclosure. Furthermore, not all constituent elements described in the embodiment of the present disclosure are necessarily essential in the present disclosure.

### Embodiment

### Schematic Configuration Example of Information Processing System

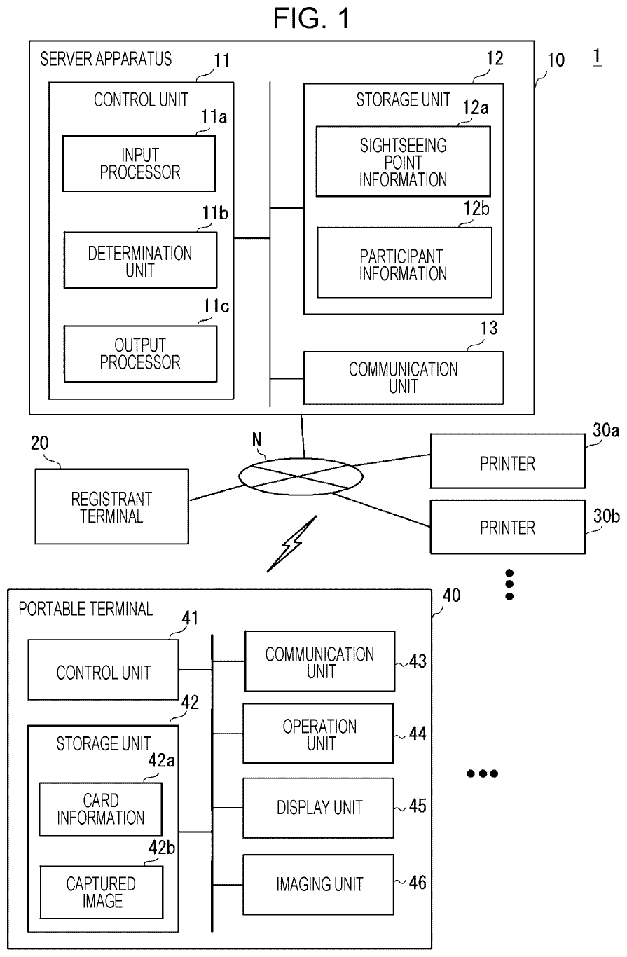

Hereinafter, a configuration example of an information processing system according to the present embodiment will be described with reference to FIG. 1. FIG. 1 is a block diagram illustrating the configuration example of the information processing system according to the present embodiment.

The information processing system according to the present embodiment (hereinafter referred to as the present system) is a system for providing a participant with a tour event to visit a plurality of tour points, such as a sightseeing event to visit a plurality of sightseeing points. As will be described in detail later, the present system provides the participant with a tour event toward a destination point via a relay point. In the tour event, the participant is provided with a card as printed matter or an electronic file. Hereinafter, sightseeing points will be described as an example of the tour points, but the tour points may be points visited for purposes other than sightseeing.

The present system can include a server apparatus 10, a registrant terminal 20, a plurality of printers 30a, 30b, . . . , and a portable terminal 40, as exemplified by an information processing system 1 in FIG. 1. The printers 30a, 30b, . . . will be referred to as a printer 30 when they are not distinguished from each other.

The server apparatus 10, a configuration example of which will be described later, is an information processing apparatus that provides the tour event and may be installed anywhere. The server apparatus 10 is connected to the registrant terminal 20, the printer 30, and the portable terminal 40 via a network N. The network N can include, for example, a local area network (LAN), a mobile communication network, or the like. As a matter of course, each apparatus, terminal, or printer in the information processing system 1 may be connected in any form. For example, the server apparatus 10 may be connected to the registrant terminal 20 and the printer 30 via a first network including a LAN or a wireless LAN. For example, the server apparatus 10 may be connected to the portable terminal 40 via a second network including a wireless LAN or a mobile communication network.

Note that the portable terminal 40 may be configured to perform direct wireless communication with the printer 30 by wireless communication of a short-range wireless communication standard such as Bluetooth (registered trademark), a Wi-Fi (registered trademark) Direct function, or the like.

For simplification of description, the following description assumes that the server apparatus 10 includes one information processing apparatus such as one server computer. However, the server apparatus 10 can also be constructed as a distributed system in which the functions are distributed to a plurality of information processing apparatuses. As an example, the server apparatus 10 can be a distributed system including, for example, a web server computer that performs browsing, transmission, and reception of information from the portable terminal 40 and a server computer that performs other functions. As a matter of course, the method of distributing the functions in the server apparatus 10 is not limited to this example.

The registrant terminal 20 is a terminal used by a registrant. The registrant is an operator of the information processing system 1 or an administrator user who administers the information processing system 1 and refers to a person who registers information for providing the tour event. The terminal is a portable terminal, which is a mobile terminal, or a stationary terminal, and can refer to, for example, an information processing apparatus having a communication function, such as a personal computer (PC), a smartphone, or a tablet terminal. As a matter of course, the information processing system 1 can include a plurality of registrant terminals 20.

One or more printers 30 are installed at each sightseeing point. For example, the printer 30a is installed at a sightseeing point, and the printer 30b is installed at another sightseeing point. The printer 30 can also be referred to as an image forming apparatus. As will be described later, in the tour event provided by the information processing system 1, a card is provided to a participant. The card may be printed matter, but may also be provided to the participant only as an electronic file rather than printed matter. In such a configuration, the information processing system 1 does not need to include the printer 30.

The portable terminal 40 is, for example, an information processing apparatus having a communication function, such as a notebook PC, a smartphone, or a tablet terminal, and is an example of a terminal used by a participant who participates in the tour event. As a matter of course, since a plurality of participants can simultaneously participate in the tour event provided by the information processing system 1, it can be said that the information processing system 1 can include a plurality of portable terminals 40.

The present system can be regarded as a configuration including only the server apparatus 10, but can also be regarded as a configuration including at least one of the registrant terminal 20, the printer 30, and the portable terminal 40 in addition to the server apparatus 10. Hereinafter, a configuration example of each apparatus, terminal, or printer of the information processing system 1 will be described.

### Schematic Configuration Example of Server Apparatus 10

As illustrated in FIG. 1, the server apparatus 10 can include a control unit 11, a storage unit 12, and a communication unit 13.

The control unit 11 of the server apparatus 10 performs overall control of the server apparatus 10. The control unit 11 can include an input processor 11a, a determination unit 11b, and an output processor 11c, which will be described later in a detailed configuration example of the information processing system 1.

The control unit 11 may be configured to include, for example, an arithmetic processing unit such as a CPU or a GPU, a working memory, and a storage device that stores a control program, parameters, and the like. Note that “CPU” is an abbreviation for a central processing unit, and “GPU” is an abbreviation for a graphics processing unit. The control unit 11 can also be configured as a system on a chip (SoC). As is also clear from these examples, the control unit 11 can be configured to store the control program in an executable state. However, the control unit 11 can also be configured to store the control program as a circuit configuration such as a field-programmable gate array (FPGA), or may be configured as a dedicated circuit.

The input processor 11a, the determination unit 11b, and the output processor 11c can be implemented as, for example, the above-described control program. That is, the above-described control program can include a program for realizing the functions of the input processor 11a, the determination unit 11b, and the output processor 11c in cooperation with the storage unit 12 and the communication unit 13.

The storage unit 12 is, for example, a hard disk drive, a solid-state drive, or another memory. Part of the memory included in the control unit 11 may be regarded as the storage unit 12. The storage unit 12 can also be regarded as part of the control unit 11. The storage unit 12 can store sightseeing point information 12a in accordance with an instruction from the control unit 11. Further, the storage unit 12 can store participant information 12b in accordance with an instruction from a control unit 41.

The communication unit 13 can be one or more communication interfaces for the server apparatus 10 to communicate with an external apparatus via the network N, which is wired or wireless, in conformity with a predetermined communication protocol including a predetermined communication standard. The external apparatus is the registrant terminal 20, the printer 30, the portable terminal 40, or the like.

For example, the communication unit 13 can receive information and an image to be included in the sightseeing point information 12a from the registrant terminal 20 via the network N. In addition, the communication unit 13 can receive information and an image to be included in the participant information 12b and a captured image 42b from the portable terminal 40 via the network N. Further, the communication unit 13 can transmit print data of a card to the printer 30 via the network N. Moreover, the communication unit 13 can transmit display information for displaying an operation image on the portable terminal 40 and card information 42a to the portable terminal 40 via the network N. The operation image refers to a user interface (UI) image provided from the server apparatus 10.

### Schematic Configuration Example of Portable Terminal 40

As illustrated in FIG. 1, the portable terminal 40 can include the control unit 41, a storage unit 42, a communication unit 43, an operation unit 44, a display unit 45, and an imaging unit 46.

The control unit 41 of the portable terminal 40 executes overall control of the portable terminal 40. The control unit 41 can be configured to include, for example, an arithmetic processing unit such as a CPU or a GPU, a working memory, and a storage device that stores a control program, parameters, and the like. The control unit 41 can also be configured as an SoC. As is also clear from these examples, the control unit 41 can be configured to store the control program in an executable state. However, the control unit 41 can also be configured to store the control program as a circuit configuration such as an FPGA, or can be configured as a dedicated circuit. The above-described control program can be a program for realizing the functions of the portable terminal 40 in cooperation with the storage unit 42, the communication unit 43, the operation unit 44, the display unit 45, and the imaging unit 46.

The storage unit 42 is, for example, a hard disk drive, a solid-state drive, or another memory. Part of the memory included in the control unit 41 may be regarded as the storage unit 42. The storage unit 42 can also be regarded as part of the control unit 41. The storage unit 42 can store, for example, the card information 42a received from the server apparatus 10 via the communication unit 43 in accordance with an instruction from the control unit 41. In addition, the storage unit 42 can store a captured image 42b captured by the imaging unit 46 in accordance with an instruction from the control unit 41.

The communication unit 43 can be one or more communication interfaces for the portable terminal 40 to communicate with one or more external apparatuses via the network N, which is wired or wireless, in conformity with a predetermined communication protocol including a predetermined communication standard. The external apparatus is the server apparatus 10, both the server apparatus 10 and the printer 30, or the like.

For example, the communication unit 43 can transmit information and an image to be included in the participant information 12b or a captured image 42b captured by the imaging unit 46 to the server apparatus 10 via the network N. In addition, the communication unit 43 can receive display information for displaying the card information 42a and the operation image from the server apparatus 10 via the network N. Further, the communication unit 43 can be configured to transmit print data of a card indicated by the card information 42a to the printer 30 via the network N or a short-range wireless communication network.

The display unit 45 is a unit for displaying information. The display unit 45 includes, for example, a display device such as a liquid crystal display or an organic EL display. The display unit 45 can also include a display and a drive circuit for driving the display. The display unit 45 can display the operation image indicated by the display information provided from the server apparatus 10. The operation image is an image that can be operated from the operation unit 44. The display unit 45 can also display the card information 42a received from the server apparatus 10.

An application program for the tour event, for executing a process of displaying such display information, a process of displaying the received card information 42a, and the like, may be installed in the portable terminal 40.

The operation unit 44 is a unit that receives an operation or an input by a user, and can also be referred to as an operation receiving unit. The operation unit 44 can receive an operation on the operation image displayed on the display unit 45. The operation unit 44 can be implemented by, for example, one or more of a physical button, a touch panel or a touch sensor mounted on the display unit 45, a pointing device, a keyboard, and the like. In a configuration in which the operation unit 44 includes a touch panel or a touch sensor, the display unit 45 and the touch panel can also be collectively referred to as an operation panel of the portable terminal 40.

The imaging unit 46 is an imaging device that captures a still image or a moving image. The imaging unit 46 can also be referred to as a camera. The control unit 41 can cause the storage unit 42 to store a captured image 42b captured by the imaging unit 46.

### Schematic Configuration Example of Registrant Terminal 20

Although a configuration example of the registrant terminal 20 is not described in detail, the registrant terminal 20 can include a control unit, a storage unit, a display unit, an operation unit, and a communication unit, similarly to the portable terminal 40. An operation image displayed on the display unit of the registrant terminal 20 can also be provided from the server apparatus 10. In addition, an application program for the administrator of the tour event for executing a process of displaying such display information, a process of registering the sightseeing point information 12a, and the like may be installed in the registrant terminal 20.

### Schematic Configuration Example of Printer 30

Although not illustrated, the printer 30 can include a communication unit that performs the reception of print data to be printed and other operations, a printing unit that performs printing, and a display unit and an operation unit serving as an interface that receives an operation from the user.

The printing unit performs printing on a medium on the basis of, for example, print data of a card received from the server apparatus 10 or the portable terminal 40, or the like. Thus, an image indicated by the print data is formed on the medium, and a card as printed matter is produced. The printing method in the printing unit is not particularly limited, and, for example, various printing methods such as an ink jet printing method and a laser printing method can be applied. The printer 30 may be a multifunction peripheral having a facsimile function, a copy function, and the like, in addition to the printing function.

### Detailed Configuration Example of Information Processing System 1

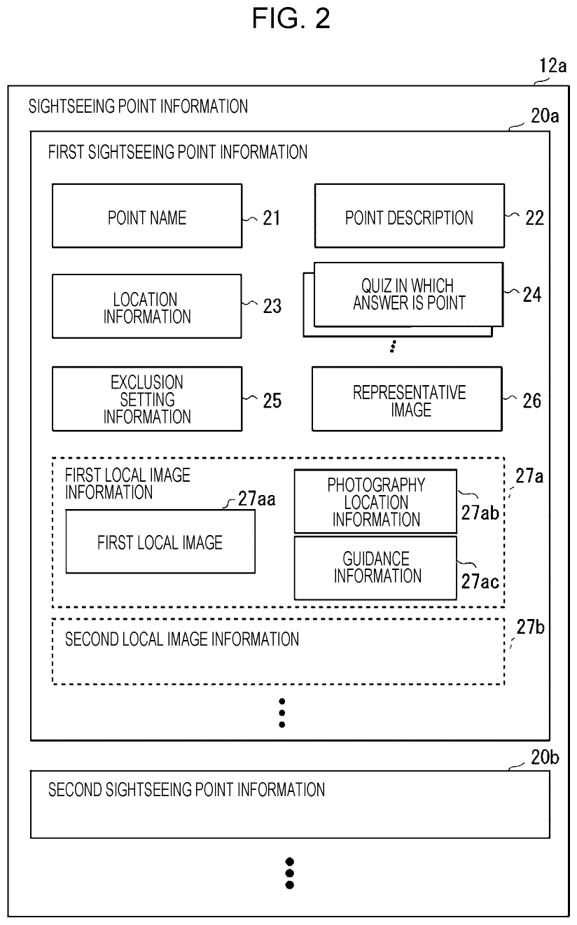

As a detailed configuration example of the information processing system 1, details of the control unit 11 of the server apparatus 10, including transmission and reception of information to and from the registrant terminal 20, the printer 30, and the portable terminal 40, will be mainly described. Here, the description will be given with reference to FIG. 2, together with a detailed example of the sightseeing point information 12a. FIG. 2 is a diagram illustrating an example of information stored as the sightseeing point information 12a in the storage unit 12 of the information processing system 1 of FIG. 1.

In the information processing system 1, as a schematic flow, a sightseeing point in the tour event is registered in the server apparatus 10 from the registrant terminal 20, the participant designates a destination point in the server apparatus 10 from the portable terminal 40, and the server apparatus 10 determines a sightseeing route. The tour event is a game event to search for the destination point from a starting point via a relay point. It is sufficient that, as the starting point, a point such as a sightseeing point is determined in advance for each tour event. The participant starts sightseeing based on the tour event from the starting point.

Next, the information processing system 1 repeats providing a card related to the next relay point to the participant to direct the participant to the relay point, and guides the participant to the destination point. When the participant arrives at the destination point, the information processing system 1 also provides a card to the participant. Since the information processing system 1 is a system that generates and outputs a card as described above, it can be referred to as a card generation system or a card output system. Since the tour event is an event to visit points one by one as described above, the relay point determined to be included in the sightseeing route or both the starting point and the relay point can be referred to as a checkpoint. The destination point designated for the sightseeing route can be referred to as a goal point.

In order to provide such a tour service to the participant, the information processing system 1 has the above-described configuration. In particular, the server apparatus 10 can include the storage unit 12, which stores the sightseeing point information 12a and the participant information 12b, and the control unit 11, which includes the input processor 11a, the determination unit 11b, and the output processor 11c.

The input processor 11a includes an interface between the control unit 11 and the communication unit 13. The input processor 11a and the communication unit 13 are examples of an input unit that inputs information including designation information to be described later. The following description provides an example in which the input unit inputs both the sightseeing point information 12a and the participant information 12b.

The sightseeing point information 12a is registered by the registrant in the storage unit 12 of the server apparatus 10 from the registrant terminal 20 via the network N. Specifically, the registrant terminal 20 accesses the server apparatus 10 and obtains an operation image for registration in accordance with the operation of the registrant. This operation image can be displayed on the display unit of the registrant terminal 20 by using, for example, a web browser or the like, or by using the installed application program for the administrator of the tour event. Then, the registrant performs, on the operation image, an operation of selecting information to be registered from information stored in the storage unit (not illustrated). The registrant terminal 20 transmits the information thus selected to the server apparatus 10 as information to be registered.

In the server apparatus 10, the input processor 11a receives the selected information to be registered via the communication unit 13, and stores the information in the storage unit 12 as part of the sightseeing point information 12a. It is sufficient that such processing is executed for each piece of information to be registered before the tour event is provided. The input processor 11a functions as a unit that performs a process of registering the sightseeing point information 12a at this time.

The sightseeing point information 12a includes a representative image, which is a representatively-acquired image showing a sightseeing point, and a local image, which shows a locally-acquired image at the sightseeing point, for each of a plurality of sightseeing points. The sightseeing points can refer to points such as sightseeing facilities and sightseeing spots, and the types of sightseeing are not limited. The local image can be an image from which the participant cannot recognize the sightseeing point at a glance or cannot recognize a specific location in the sightseeing point.

It is sufficient that both the representative image and the local image are photographic images captured by a camera and processed as necessary. However, one or both of the representative image and the local image may be illustrated images. Since the local image shows a locally-acquired image at the sightseeing point shown in the representative image, it can be said that the local image is a locally-acquired image related to the corresponding representative image. Not only one local image but also a plurality of local images can be stored for one sightseeing point. The local images stored for one sightseeing point preferably show locally-acquired images different from each other. However, a local image of one sightseeing point may show the same locally-acquired image as another local image of the same sightseeing point. For example, two local images of one sightseeing point may be a photographic image and an illustrated image, photographic images having different angles of view, or the like.

The sightseeing point information 12a illustrated in FIG. 2 includes sightseeing point information on each sightseeing point such as first sightseeing point information 20a and second sightseeing point information 20b. Although illustration and description are omitted, information of the types included in the first sightseeing point information 20a is similarly included in other sightseeing point information such as the second sightseeing point information 20b.

The first sightseeing point information 20a includes a representative image 26 and a plurality of pieces of local image information such as first local image information 27a, second local image information 27b, The first local image information 27a can include a first local image 27aa, photography location information 27ab indicating the photography location of the first local image 27aa, and guidance information 27ac for guiding the participant to the photography location. The photography location information 27ab can be, for example, latitude-longitude information. In addition, although illustration and description are omitted, information of the types included in the first local image information 27a is similarly included in other local image information such as the second local image information 27b.

As exemplified for the first sightseeing point information 20a, the sightseeing point information 12a registered by the registrant can include a point name 21, a point description 22, location information 23, a quiz 24 in which the answer is a point, and exclusion setting information 25, in addition to the representative image 26 and a plurality of pieces of local image information. Part or all of the sightseeing point information 12a is not necessarily registered by the registrant, but may be automatically collected from the Internet or the like, for example.

The point name 21 is the name of a target sightseeing point. The point description 22 is a sentence describing the sightseeing point such as a comment on the sightseeing point. The location information 23 is information indicating the location of the sightseeing point, and can be, for example, latitude-longitude information, an address, or the like.

The quiz 24 is an example of information for the participant to access and arrive at the sightseeing point, and is, for example, a quiz in which the answer is the point name 21 or a feature of the sightseeing point. The quiz 24 can be prepared by the registrant, an event organizer, or the like. The quiz 24 can include a specific hint regarding the place where a local image of the sightseeing point was taken, for example, the south side of an observation platform. The target local image of the quiz 24 is an image showing the final goal point at the destination point designated by the participant, which will be described later. Therefore, for example, when the goal point is the place where the first local image 27aa was taken, the target local image of the quiz 24 is the first local image 27aa.

The exclusion setting information 25 can be at least one of information indicating whether a sightseeing point should be excluded from the candidates to be designated as the destination point by the participant, and information indicating whether the sightseeing point should be excluded from the candidates to be determined as the relay point.

The exclusion setting information 25 is information set in the server apparatus 10, for example, as part of the sightseeing point information 12a as described above or in association with the sightseeing point information 12a. To enable such setting, the server apparatus 10 preferably includes a setting unit that sets a sightseeing point to be excluded from either the designation targets for the destination point or the determination targets for the relay point, among the plurality of sightseeing points indicated by the sightseeing point information 12a. The setting unit can be exemplified by the communication unit 13, the input processor 11a, and the storage unit 12. For example, as the setting unit, the input processor 11a inputs the content of the setting operation from the registrant terminal 20 via the communication unit 13, and the storage unit 12 stores the sightseeing point to be excluded as part of the sightseeing point information 12a in accordance with the content of the setting operation.

By enabling the above-described setting of the exclusion setting information 25, it is possible to, for example, set and reflect the registrant's request in the server apparatus 10, when the sightseeing points registered by the registrant include a point that the registrant requests to be selected only as the destination point or as the relay point. The reflection means that the point is not designated as the destination point by the participant or the point is not determined as the relay point.

For example, it is preferable to set the exclusion setting information 25 such that a sightseeing point that the registrant does not think suitable for long-term stay is excluded from the candidates for the destination point, when the registrant does not want the sightseeing point to be designated as the destination point in order to avoid congestion. Further, for example, it is preferable to set the exclusion setting information 25 such that a sightseeing point that the registrant wants the participant to visit as a sightseeing attraction is not excluded from the candidates for both the destination point and the relay point.

Basically, it is preferable to set the exclusion setting information 25 such that the sightseeing point to be excluded from the determination candidates for the relay point is not excluded from the designation candidates for the destination point and the sightseeing point to be excluded from the designation candidates for the destination point is not excluded from the determination candidates for the relay point. For example, it is preferable to set the exclusion setting information 25 such that the sightseeing point to be set only as the destination point is excluded from the determination candidates for the relay point and the sightseeing point to be set only as the relay point is excluded from the designation candidates for the destination point.

The above-described setting unit can also automatically set a sightseeing point for which no local image is registered in the sightseeing point information 12a to be excluded from the determination candidates for the relay point. As will be described later, this is because the card to be output for the relay point can be, for example, a card that does not include a local image but includes a representative image. In addition, the above-described setting unit can also automatically set a sightseeing point for which no representative image is registered in the sightseeing point information 12a to be excluded from the designation candidates for the destination point. As will be described later, this is because the card to be output for the destination point can be, for example, a card that does not include a representative image but includes a local image.

The participant information 12b is registered by the participant in the storage unit 12 of the server apparatus 10 from the portable terminal 40 via the network N. Specifically, the portable terminal 40 used by the participant accesses the server apparatus 10 and obtains an operation image for participation registration in accordance with the operation of the participant. This operation image can be displayed on the display unit 45 of the portable terminal 40 by using, for example, a web browser or the like, or by using the installed application program for the tour event. Then, the participant performs an operation of inputting personal information for specifying the participant such as a name on the operation image. The portable terminal 40 transmits the personal information thus input to the server apparatus 10 as the participant information 12b of the tour event.

In the server apparatus 10, the input processor 11a receives the input personal information of the participant via the communication unit 13, and the personal information is stored in the storage unit 12 as part of the participant information 12b. Two or more participants may be registered as group participants at the same time. It is sufficient that the participant who participates in the tour event performs an operation of registering the participant information 12b at the starting point or in advance before arriving at the starting point. In the case of registration before the arrival at the starting point, that is, advance registration, the input of a participation date and time is preferably also received as part of the personal information and registered as part of the participant information 12b. The input processor 11a functions as a unit that performs a process of registering the participant information 12b at this time.

When the sightseeing point information 12a and the participant information 12b are registered in the storage unit 12, the participant of sightseeing indicated by the participant information 12b designates the destination point of sightseeing using the portable terminal 40. Specifically, the portable terminal 40 used by the participant accesses the server apparatus 10 and obtains an operation image for designating the destination point in accordance with the operation of the participant. This operation image can also be displayed on the display unit 45 of the portable terminal 40 by using, for example, a web browser or the like, or by using the application program for the tour event.

This operation image is an image for selecting one of a plurality of sightseeing points indicated by the sightseeing point information 12a, and preferably includes, for example, a list of local images of the plurality of sightseeing points as options. However, a list of representative images or a list of place names indicated by point names 21 may be adopted instead of the list of local images.

In a configuration in which the exclusion setting information exemplified by the exclusion setting information 25 in the first sightseeing point information 20a is registered as part of the sightseeing point information 12a, the plurality of sightseeing points presented to the participant do not include any sightseeing point set to be excluded from the designation targets for the destination point in the exclusion setting information included in each piece of sightseeing point information.

Then, the participant browses the operation image to determine the destination point, and performs an operation of selecting the determined destination point on the operation image. The portable terminal 40 transmits designation information, which is the information thus designated, to the server apparatus 10. The designation of the designation information may be executed together with the input of the participant information 12b.

The designation information received by the server apparatus 10 is information indicating the destination point of sightseeing designated by the participant of sightseeing from the plurality of sightseeing points. As described above, the designation information can be information indicating the destination point designated by the participant from, for example, all the sightseeing points stored as the sightseeing point information 12a in the storage unit 12. That is, the designation information can be information indicating the destination point of sightseeing designated by the participant of sightseeing from the plurality of sightseeing points stored in the storage unit 12. However, as described in the example of registration of the exclusion setting information 25, the designation information can also be information indicating the destination point designated by the participant from, for example, some sightseeing points of all the sightseeing points stored as the sightseeing point information 12a in the storage unit 12. In addition, as described in the example in which the operation image includes the list of local images, the designation information may be information indicating the destination point designated as the destination point by the participant from the respective local images of the plurality of sightseeing points.

In the server apparatus 10, the communication unit 13 receives the designation information, and the input processor 11a receives the designation information and passes it to the determination unit 11b. At this time, the input processor 11a functions as a unit that performs a process of setting the designation information in the determination unit 11b.

The determination unit 11b and the output processor 11c are examples of a control unit that determines the sightseeing route of the participant and outputs a card related to a point included in the sightseeing route to an output destination. The card to be output is a card corresponding to the target point or the like, and includes a first card and a second card to be described later, and may further include at least one of a third card and a fourth card to be described later. Hereinafter, the functions of the determination unit 11b and the output processor 11c will be specifically described.

The determination unit 11b refers to the sightseeing point information 12a and determines the relay point from the plurality of sightseeing points indicated by the sightseeing point information 12a, on the basis of the destination point designated by the designation information received from the input processor 11a. This determination can be randomly made, for example. By introducing randomness into the determination, the sightseeing route, to be described later, is not uniquely determined with respect to the starting point and the destination point. This can further prevent the participant from losing interest when participating more than once.

However, in a configuration in which the exclusion setting information exemplified by the exclusion setting information 25 in the first sightseeing point information 20a is registered as part of the sightseeing point information 12a, the relay point to be determined does not include any sightseeing point set to be excluded from the determination targets for the relay point in the exclusion setting information included in each piece of sightseeing point information.

Although the example in which the relay point is randomly determined has been described, it is not necessary to randomly determine all relay points. For example, the determination unit 11b may select relay candidate points based on the destination point designated by the designation information and randomly select one or more relay points from the selected relay candidate points, thereby determining the one or more relay points.

Further, the determination unit 11b determines the sightseeing route based on the destination point and the relay point. The above-described process in which the determination unit 11b determines the relay point and the sightseeing route means the process in which the determination unit 11b determines the sightseeing route based on the destination point.

The determination unit 11b can determine, for example, a route that includes the destination point and the relay point and can be traveled in the shortest distance, that is, a route that connects the destination point and the relay point in the shortest distance, as the sightseeing route. However, the present disclosure is not limited to this. For example, in the case of a route within a narrow area or the like, there is no problem for the participant even when the sightseeing route is determined regardless of whether the route can be traveled in the shortest distance. For example, the participant may be prompted to input the time at which the participant can participate when selecting the destination point, and when it is determined from the time that there is sufficient time available, a sightseeing route that is not the shortest route may be determined.

The determination unit 11b preferably stores the determined sightseeing route including the destination point and the relay point in the storage unit 12 in association with the participant information 12b indicating the target participant. The sightseeing route basically includes the starting point as well, and the starting point can also be processed as the first relay point.

The output processor 11c outputs a first card to an output destination, when the input processor 11a inputs point information indicating the arrival of the participant at a processing target point, which is one of the starting point and the relay point of the determined sightseeing route. Hereinafter, this point information is referred to as target point arrival information.

In other words, the output processor 11c outputs the first card to the output destination upon receiving the input of the target point arrival information from the portable terminal 40 of the participant via the communication unit 13. An example of the first card will be described later. For example, it is possible to generate a first card at the time of receiving the input of the target point arrival information, or to read a first card generated and stored in advance in the storage unit 12 before or at the time of determination of the sightseeing route. It can be said that the output processor 11c or the control unit 11 can include a generation unit that generates a card such as a first card.

The target point arrival information is information from which it can be determined that the participant has arrived at the processing target point. That is, the target point arrival information is information indicating the arrival of the participant at the processing target point. The target point arrival information can be, for example, information obtained by imaging and reading point identification information presented at an arrival point using the imaging unit 46 of the portable terminal 40 of the participant. The point identification information presented at the point may be a two-dimensional barcode such as a QR code (registered trademark, the same applies hereinafter), a one-dimensional barcode, or a simple character string. Such a barcode or a character string is information having the meaning of an identification number or a password for proceeding to the next sightseeing point. Alternatively, the target point arrival information may be location information indicating the location of the portable terminal 40 of the participant acquired at the arrival point. By including a global navigation satellite system (GNSS) reception unit (not illustrated), the portable terminal 40 can acquire the location information. The location information means point identification information received or provided from the portable terminal 40.

In practice, the portable terminal 40 of the participant transmits information in the same format as the target point arrival information to the server apparatus 10 as arrival determination information for determination. For example, the input processor 11a determines whether the participant has arrived on the basis of the arrival determination information. Then, the arrival determination information is preferably passed to the output processor 11c as the target point arrival information, only when the input processor 11a determines that the participant has arrived at the processing target point. Thus, the output processor 11c does not output a first card when the arrival determination information does not indicate the arrival at the processing target point, and can output a first card only when the arrival determination information indicates the arrival.

The first card is a type of card output by the output processor 11c, and is a card related to the next sightseeing point along the sightseeing route. For example, the first card can include information indicating a quiz regarding the next sightseeing point, and this information can be obtained by reading the information exemplified by the quiz 24, in which the answer is a point. That is, by checking the first card, the participant is directed or guided to the next sightseeing point as the next objective. Accordingly, the first card can be referred to as a direction card, a guidance card, or an objective card. When the processing target point is the starting point of the tour event, the next sightseeing point means the first relay point. When the processing target point is a relay point, the next sightseeing point means the next relay point or the destination point.

The first card includes a representative image of the processing target point or a representative image of the next sightseeing point following the processing target point along the sightseeing route. When the first card includes the representative image of the processing target point, the first card can have the meaning of a reward for arrival at the processing target point. In this case, it is preferable that the first card also include information indicating the next sightseeing point, thereby having a meaning as a direction card as well. When the first card includes the representative image of the next sightseeing point, the first card has a meaning as a direction card. In this case, when the first card includes information indicating the next sightseeing point in addition to the representative image, it is easier to direct the participant.

The output destination of the first card is the portable terminal 40, which is the transmission source of target point arrival information, and the portable terminal 40 stores card information 42a, which is a received electronic file card, in the storage unit 42. The card information 42a can be displayed on the display unit 45 by the operation of the participant. However, the output destination of the first card may be the printer 30 installed at the processing target point, or may be both the portable terminal 40 and the printer 30. That is, the output processor 11c preferably outputs the first card to, as the output destination, at least one of the portable terminal 40 of the participant who has arrived at the processing target point, at which the first card is output, and the printer 30 installed at the processing target point, at which the first card is output. For example, when the printer 30a is installed at the processing target point, the output destination of the first card can be the printer 30a, can be the portable terminal 40, or can be both the printer 30a and the portable terminal 40.

When the input processor 11a inputs point information indicating the arrival of the participant at the destination point, the output processor 11c outputs a second card to an output destination. In the following description, the point information indicating the arrival of the participant at the destination point is referred to as destination point arrival information, and is distinguished from the target point arrival information.

In other words, the output processor 11c outputs the second card to the output destination upon receiving the input of the destination point arrival information from the portable terminal 40 of the participant via the communication unit 13. An example of the second card will be described later. For example, it is possible to generate a second card at the time of receiving the input of the destination point arrival information, or to read a second card generated and stored in advance in the storage unit 12 before or at the time of determination of the sightseeing route.

The destination point arrival information is information from which it can be determined that the participant has arrived at the destination point. That is, the destination point arrival information is information indicating the arrival of the participant at the destination point. Similarly to the target point arrival information, the destination point arrival information can be information obtained by reading a QR code or the like, or location information of the portable terminal 40.

In practice, the portable terminal 40 of the participant transmits information in the same format as the destination point arrival information to the server apparatus 10 as arrival determination information for determination. For example, the input processor 11a determines whether the participant has arrived on the basis of the arrival determination information. Then, the arrival determination information is preferably passed to the output processor 11c as the destination point arrival information, only when the input processor 11a determines that the participant has arrived at the destination point. Thus, the output processor 11c does not output a second card when the arrival determination information does not indicate the arrival at the destination point, and can output a second card only when the arrival determination information indicates the arrival.

The second card is a type of card output by the output processor 11c, and is a card related to the destination point. The second card can be provided to the participant with the meaning of a reward for completing the tour event. Thus, the second card can also be referred to as a reward card. The second card can include, for example, a local image of the destination point.

Similarly to that of the first card, the output destination of the second card can be at least one of the portable terminal 40 of the participant who has arrived at the destination point, at which the second card is output, and the printer 30 installed at the destination point. However, when the output destination includes the printer 30, the second card can have a strong meaning as a reward card. Note that the output destination of the first card and the output destination of the second card need not be the same as each other, such as one being the portable terminal 40 and the other being the printer 30.

When the input processor 11a inputs designation information, the output processor 11c may output a third card to an output destination. In other words, the output processor 11c may output the third card to the output destination upon receiving the input of the designation information from the portable terminal 40 of the participant via the communication unit 13. An example of the third card will be described later. For example, it is possible to generate a third card at the time of receiving the input of the designation information, or to read a third card generated and stored in advance in the storage unit 12 before or at the time of determination of the sightseeing route.

The third card is a type of card output by the output processor 11c and is a card including a local image of the destination point. The third card is a card indicating the final objective point of the tour event, and can be provided to the participant at least before the start of the tour at the starting point, at which the designation information is input, or the like. Thus, the third card can be referred to as an objective point card, a final point card, a goal card, or the like. The third card may be output, not when the designation information is input, but when the target point arrival information regarding the starting point is received as described for the first card.

Here, it is preferable that the content of an image or information presented as the third card when the participant designates the destination point be at least partially different from the content of the second card, which the participant can finally receive at the destination point. For example, when the third card includes a local image, the second card can also include the same local image, but other information, decorations, texts, and the like in the cards may be different from each other.

When the first card is output at the starting point, the first card can be output simultaneously with the third card or the first and third cards can also be output as the identical card. When the first and third cards are printed as the identical card, the content of the third card can be printed on the front side and the content of the first card on the back side, or vice versa. However, also when the first and third cards are printed as the identical card, the content of the first card and the content of the third card may be printed on one side.

The output processor 11c outputs a fourth card to an output destination when the input processor 11a inputs point information indicating the arrival of the participant at a predetermined area near the destination point. In the following description, the point information indicating the arrival of the participant at the predetermined area near the destination point is referred to as area arrival information, and is distinguished from other arrival information. The predetermined area near the destination point is not the relay point immediately before the destination point, but can refer to, for example, an entrance area of a facility of the destination point, a guidance center of the facility, or the like. The predetermined area near the destination point determined for the sightseeing route can be referred to as a checkpoint or a final checkpoint.

That is, the output processor 11c outputs the fourth card to the output destination upon receiving the input of the area arrival information from the portable terminal 40 of the participant via the communication unit 13. An example of the fourth card will be described later. For example, it is possible to generate a fourth card at the time of receiving the input of the area arrival information, or to read a fourth card generated and stored in advance in the storage unit 12 before or at the time of determination of the sightseeing route.

The area arrival information is information from which it can be determined that the participant has arrived at the predetermined area near the destination point. That is, the area arrival information is information indicating the arrival of the participant at the predetermined area near the destination point. Similarly to the target point arrival information, the area arrival information can be information obtained by reading a QR code or the like, or location information of the portable terminal 40.

In practice, the portable terminal 40 of the participant transmits information in the same format as the area arrival information to the server apparatus 10 as arrival determination information for determination. For example, the input processor 11a determines whether the participant has arrived on the basis of the arrival determination information. Then, the arrival determination information is preferably passed to the output processor 11c as the area arrival information, only when the input processor 11a determines that the participant has arrived at the predetermined area. Thus, the output processor 11c does not output a fourth card when the arrival determination information does not indicate the arrival at the predetermined area, and can output a fourth card only when the arrival determination information indicates the arrival at the predetermined area.

The fourth card is a type of card output by the output processor 11c, and is a card including a local image of the destination point, similarly to the third card. However, unlike the third card, the fourth card is output when the participant has arrived at the above-described predetermined area. Thus, the fourth card can be provided to the participant with a meaning as a final guidance when the tour event is about to end. Thus, the fourth card can also be referred to as a final direction card or a final guidance card.

When the destination point is, for example, the location indicated by the photography location information 27ab on the first local image 27aa at the sightseeing point indicated by the first sightseeing point information 20a, the location information indicating the predetermined area is preferably included in the photography location information 27ab to be managed. For example, the location information indicating the predetermined area can be information indicating the radius, in meters, from the photography location of the local image, information indicating the location of the entrance of the destination point, or the like.

The predetermined area near the destination point may be managed as a relay point near the destination point. In this case, the exclusion setting information 25 is preferably set such that this relay point is excluded from the designation candidates for the destination point. The determination unit 11b preferably determines an additionally designated destination point as one of the relay points to automatically set the additionally designated destination point as a relay point as the above-described predetermined area.

Similarly to that of the first card, the output destination of the third card or the fourth card can be at least one of the portable terminal 40 of the participant who has arrived at the point or area at which the third card or the fourth card is output, and the printer 30 installed at the point or area. The output destinations of the first card, the second card, the third card, and the fourth card do not need to be the same as each other. For example, the output destination of one or more types of cards may be the portable terminal 40, and that of the other types of cards may be the printer 30.

When any one of the first to fourth cards is output as an electronic file, the content of the card can be included in one or a plurality of pages of the electronic file, regardless of whether the first card and the third card are simultaneously output. In addition, also when a plurality of types of cards, such as the first card and the third card, are output as one electronic file, the content of the plurality of types of cards can be included in a plurality of pages of the one electronic file.

As described above, when point information at the starting point or the relay point is received from the participant, the information processing system 1 generates a first card related to the next sightseeing point in accordance with the sightseeing route determined on the basis of the designation information from the participant. In the information processing system 1, when designation information is received from the participant or point information at the starting point is received, a third card including a local image of the destination point can also be output. In addition, in the information processing system 1, when point information at the predetermined area near the destination point is received from the participant, a fourth card including a local image of the destination point can also be output. Further, the information processing system 1 outputs a second card including, for example, a local image of the destination point upon receiving point information at the destination point from the participant.

### Processing Example of Information Processing System 1

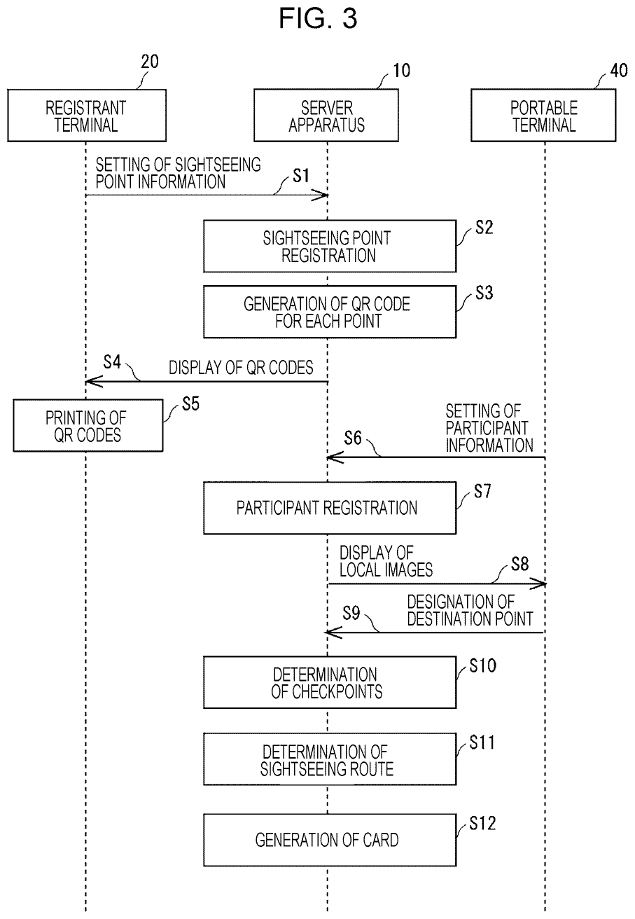

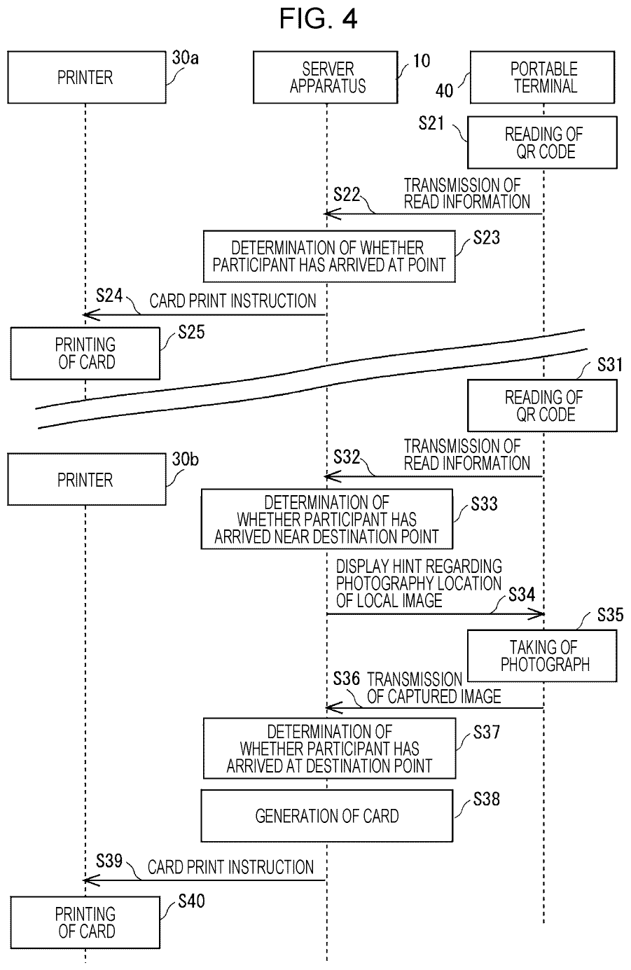

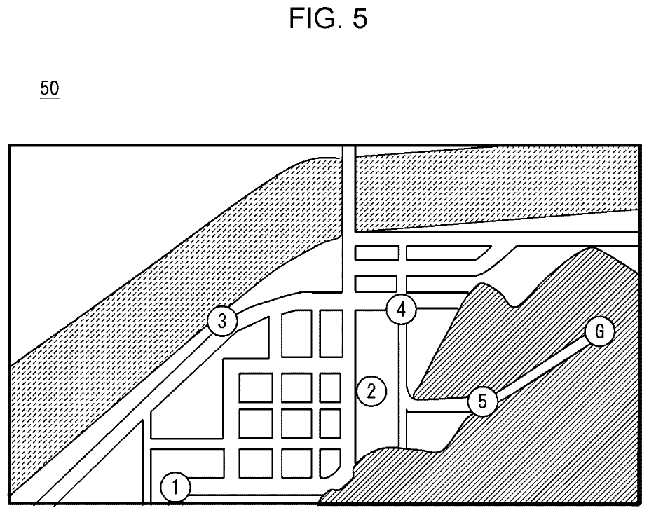

The configuration example of the information processing system 1 has been described above. Next, an example of information processing executed in the above-described configuration will be described with a specific example. Here, the flow of the information processing, illustrated mainly in FIG. 3 and FIG. 4, will be described while specific examples of cards and the like will be given with reference to FIG. 5 to FIG. 12. Also in this example, the side that participates in a game event to search for a destination point using the information processing system 1 will be described as a participant, and the side that registers sightseeing points will be described as a registrant.

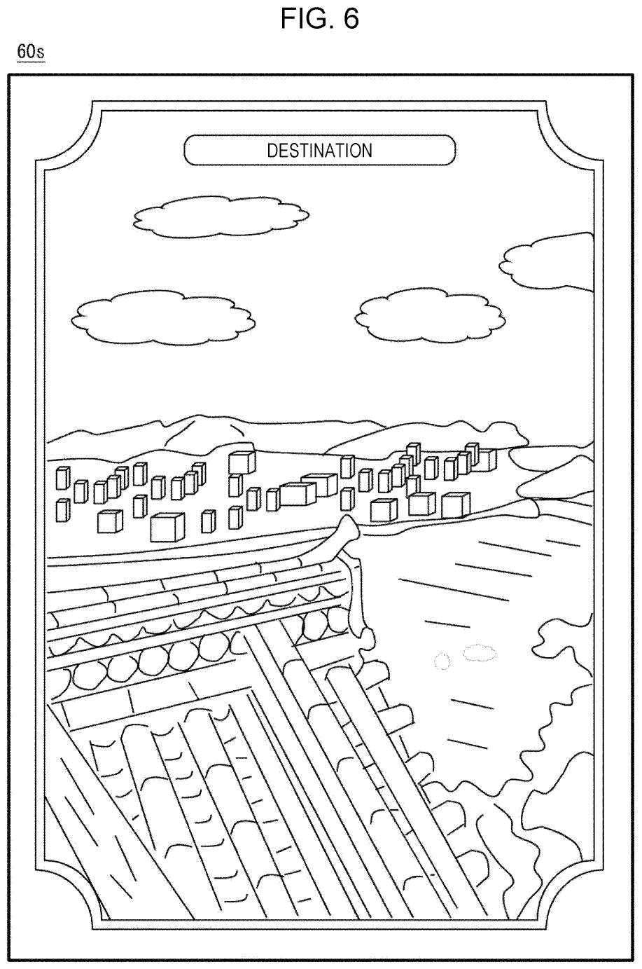

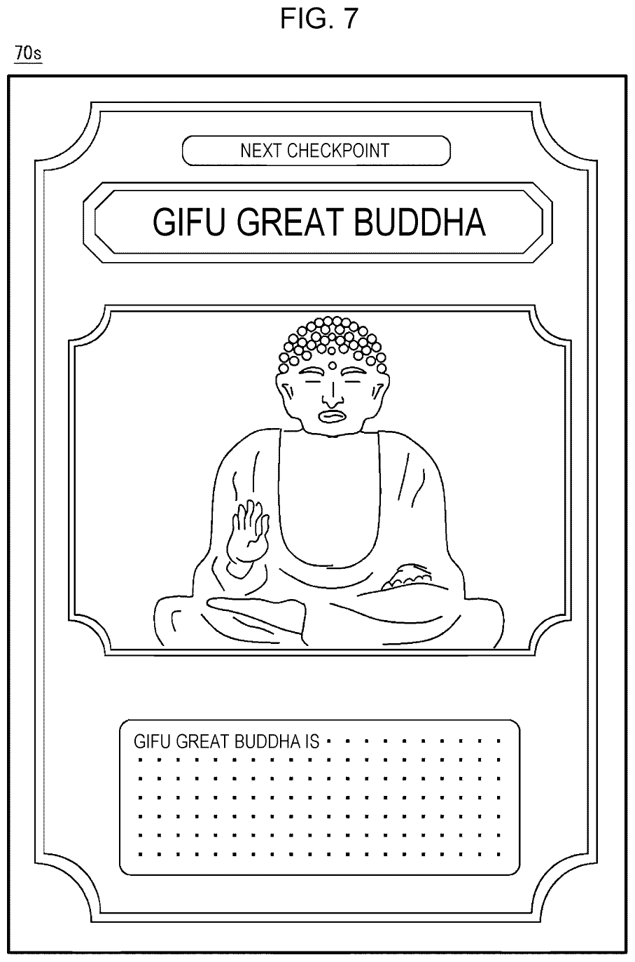

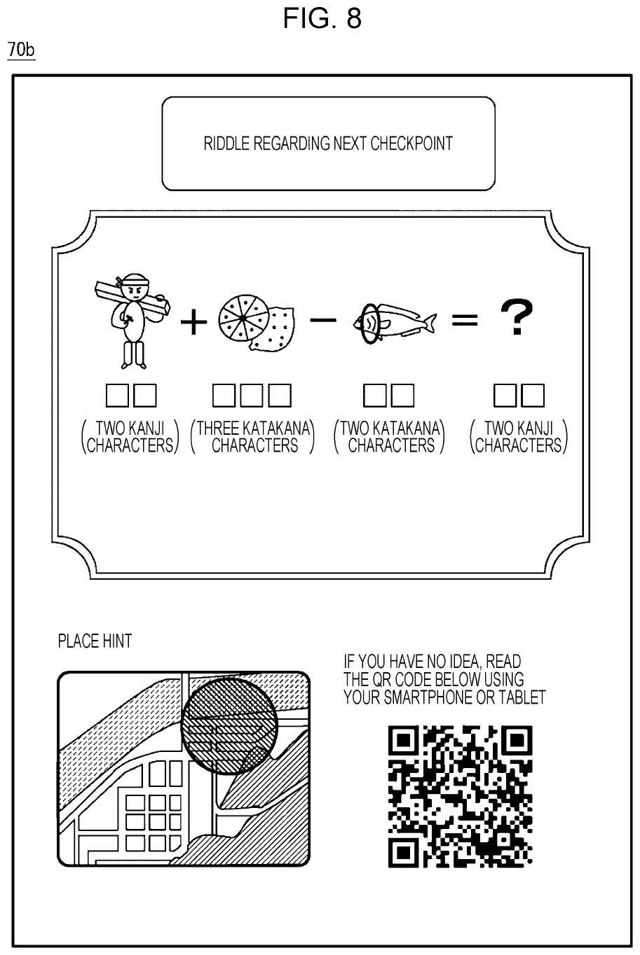

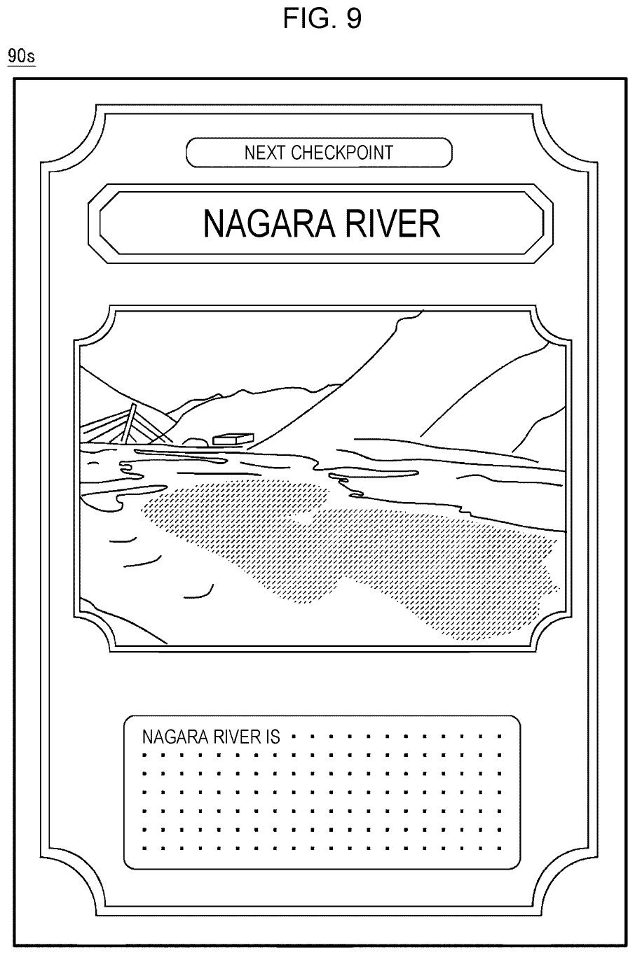

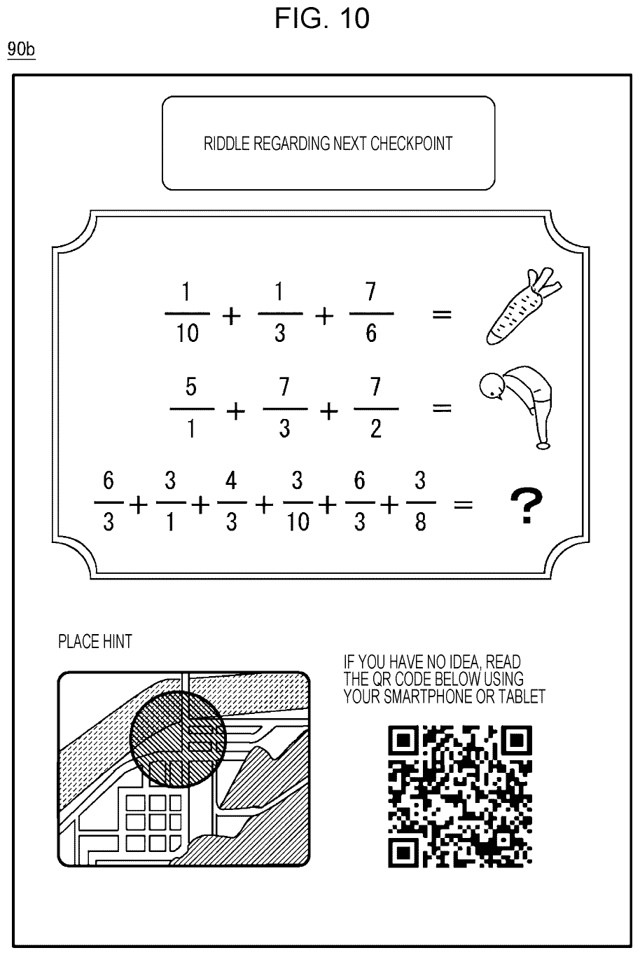

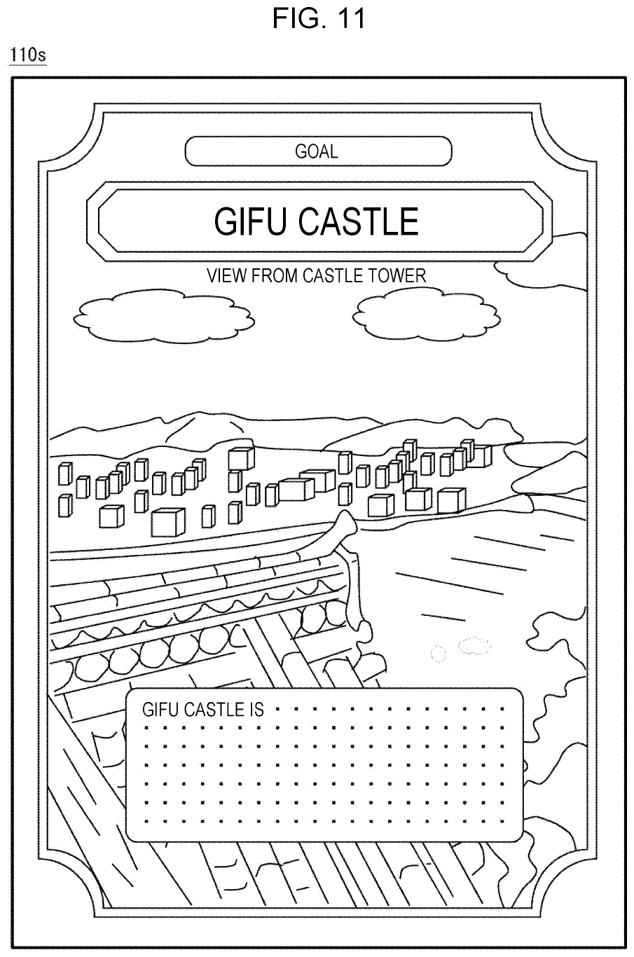

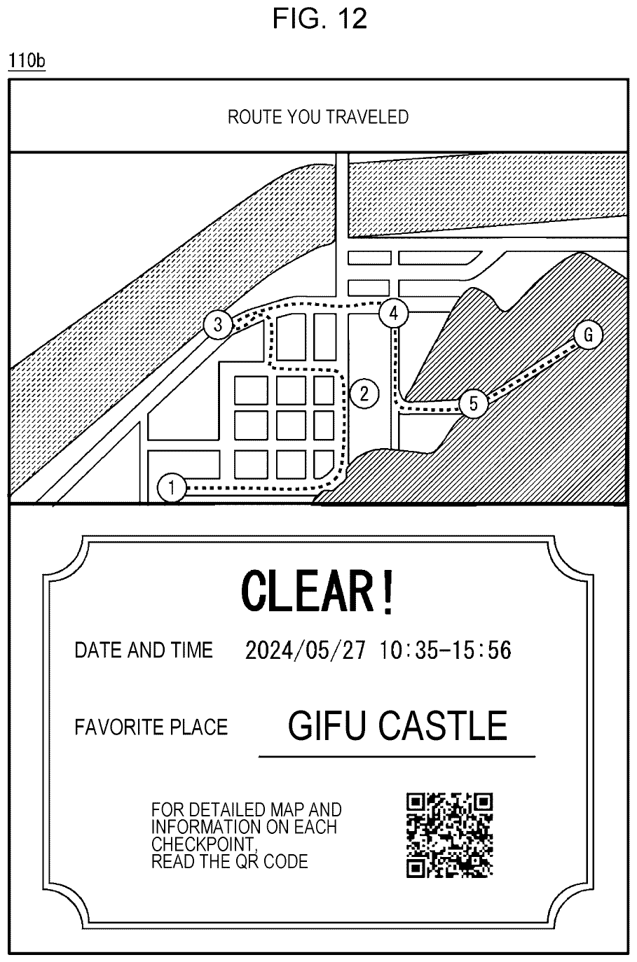

FIG. 3 is a flowchart for explaining an example of the information processing in the information processing system 1. FIG. 4 is a flowchart continued from FIG. 3. FIG. 5 is a schematic diagram illustrating an example of a sightseeing route determined in the information processing example of FIG. 3. FIG. 6 is a schematic diagram illustrating an example of a card output at a starting point in the information processing example of FIG. 3 and FIG. 4. FIG. 7 is a schematic diagram illustrating an example of the back side of the card of FIG. 6 or a second card. FIG. 8 is a schematic diagram illustrating an example of a card output at a relay point in the information processing example of FIG. 3 and FIG. 4. FIG. 9 is a schematic diagram illustrating an example of another card output at the relay point in the information processing example of FIG. 3 and FIG. 4. FIG. 10 is a schematic diagram illustrating an example of the back side of the card of FIG. 9 or a second card. FIG. 11 is a schematic diagram illustrating an example of a card output at a destination point in the information processing example of FIG. 3 and FIG. 4. FIG. 12 is a schematic diagram illustrating an example of the back side of the card of FIG. 11 or a second card.

First, the registrant performs a process of registering sightseeing point information. To be specific, in accordance with the operation of the registrant, the registrant terminal 20 accesses the server apparatus 10, displays an operation image, and sets the sightseeing point information 12a from the operation image (step S1). In response to this, the server apparatus 10 registers the sightseeing point information 12a by storing the sightseeing point information 12a in the storage unit 12 (step S2).

In step S1, for example, as described with reference to FIG. 2, the registrant can set the sightseeing point information 12a to register various information such as a photograph, a name, a description, location information, and an access method used for guidance, regarding a sightseeing point such as a sightseeing facility or a sightseeing spot. In addition, two types of photographs of a sightseeing point can be registered: a representatively-acquired photograph showing the sightseeing point and a locally-acquired photograph from which the participant cannot recognize the sightseeing point at a glance. The representatively-acquired photograph is an example of a representative image, and the locally-acquired photograph is an example of a local image. One representative image can be registered for one point, and one or more local images can be registered for one point. In addition, the registrant can set the sightseeing point information 12a to also register information such as a quiz in which the answer is the name or the feature of a point or a specific hint regarding the place where a local image was taken.

Next, the server apparatus 10 generates a QR code for each sightseeing point included in the registered sightseeing point information 12a in order to present the QR codes as point identification information (step S3). Then, the server apparatus 10 transmits the generated QR codes to the registrant terminal 20 and causes the registrant terminal 20 to display the QR codes (step S4). Next, in accordance with the printing operation of the registrant, the registrant terminal 20 causes a printer connected to the registrant terminal 20 to print each QR code (step S5). Then, the registrant attaches each printed QR code to the corresponding sightseeing point.

Next, the participant performs a process of registering the participant information 12b. To be specific, in accordance with the operation of the participant, the portable terminal 40 accesses the server apparatus 10, displays an operation image, and sets the participant information 12b from the operation image (step S6). In response to this, the server apparatus 10 registers the participant information 12b by storing the participant information 12b in the storage unit 12 (step S7).

In step S6, the participant information 12b preferably includes detailed information such as identification information for identifying the participant who participates in the tour event and personal information of the participant. The participant can participate in the tour event by registering the identification information or the like. The identification information serves as an identification (ID) for the participant to participate in the tour event, and it is sufficient that the identification information is associated with a separately set password. The personal information of the participant can include one or more of the name, age, gender, contact address, phone number, email address, emergency contact, and the like of the participant. The personal information can also include information unique to the portable terminal 40 of the participant.

The participant sets the destination point at least before participating in the tour event. To be specific, in accordance with the operation of the participant, the portable terminal 40 accesses the server apparatus 10 and displays an operation image (step S8). At this time, the server apparatus 10 may acquire the location information of the portable terminal 40 as arrival determination information. The operation image includes a list of local images, and includes an image for allowing the participant to designate one local image. This list is set so as not to include the sightseeing point to be excluded from the designation candidates for the destination point on the basis of the exclusion setting information 25.

Next, the participant performs an operation of selecting one local image from the list on the operation image, the portable terminal 40 transmits the operation content to the server apparatus 10, and the server apparatus 10 registers the destination point of the participant in accordance with the operation content (step S9). At this time, the server apparatus 10 preferably registers information indicating the destination point by incorporating the information into the participant information 12b or associating the information with the identification information of the participant information 12b. The process of steps S8 and S9 can also be performed at the same time as the registration of the identification information or the like described in steps S6 and S7. Thereafter, the participant can participate in the tour event by logging in to the server apparatus 10 using the registered identification information.

The server apparatus 10 determines a relay point based on the registered destination point of the participant. In the following description, the determined relay point is referred to as a checkpoint, and a predetermined area near the determined destination point is referred to as a checkpoint or a final checkpoint.

The server apparatus 10 randomly selects a plurality of sightseeing points, for example, approximately three to five sightseeing points from a plurality of sightseeing points excluding the destination point registered by the designation of the participant, and determines the plurality of selected sightseeing points as checkpoints (step S10). This determination may be completely random. Alternatively, a plurality of sightseeing points may be selected at random, for example, in accordance with a rule regarding at least one of the number of points and the required time designated by the participant.

Next, the server apparatus 10 automatically determines the order in which the checkpoints are to be visited, that is, the sightseeing route, so as to minimize the distance to the destination point via each checkpoint and the starting point, which is set in advance for the target tour event (step S11). When the sightseeing route including the destination point and the checkpoints determined thereafter is determined, the server apparatus 10 preferably associates the identification information of the participant with the sightseeing route. For example, the server apparatus 10 preferably associates each checkpoint or each checkpoint including the starting point with numbers indicating the order of visits, as illustrated in a sightseeing route 50 in FIG. 5, to determine the sightseeing route, and registers the identification number of the participant in association with the sightseeing route.

As described for the exclusion setting information 25, when the points registered by the registrant include a point to be selected only as the destination point or a checkpoint, the registrant preferably selects and sets the point. In this case, for example, the sightseeing point excluded from the candidates for the relay point and set only as the destination point is not selected as a checkpoint, and the point excluded from the candidates for the destination point and set only as the relay point is not selected as the destination point. In addition, the point for which no local image is registered can be automatically set as a candidate for a relay point, that is, a candidate for a checkpoint.

Next, the server apparatus 10 generates a card to be provided to the participant at the starting point (step S12). In step S12, the server apparatus 10 stores the generated card in the storage unit 12 at least until the card is output. In step S12, for example, a third card and a first card are generated.

The third card is, for example, a card indicating the final destination point of the tour event, like a third card 60s illustrated in FIG. 6, and includes a local image of the destination point. Therefore, for example, when the sightseeing point indicated by the first sightseeing point information 20a is the destination point, the third card 60s includes one local image of the first local image 27aa, the second local image, and the like as the local image of the destination point. In addition, as exemplified by the third card 60s, when the participant designates the destination point using a local image, it is sufficient that the third card includes the local image or another local image of the same destination point. A local image not including a place name or the like indicating the destination point can increase the degree of difficulty of the tour event.

The first card is a card related to the next sightseeing point along the sightseeing route. The first card output at the starting point is a card related to a checkpoint as the first relay point.

The first card generated in step S12 preferably includes, for example, a representative image of the next checkpoint, like a first card 70s illustrated in FIG. 7, but may include a representative image of the starting point instead with a meaning as a reward for arrival. The representative image can be incorporated into the first card 70s by reading the representative image 26 in the example of the first sightseeing point information 20a. In addition, as illustrated in FIG. 7, the first card 70s can include a description of the checkpoint indicated by the representative image. This description can be incorporated into the first card 70s by reading the point description 22 in the example of the first sightseeing point information 20a.

Further, the first card generated in step S12 preferably includes an image based on quiz information exemplified by the quiz 24 as a riddle regarding the next checkpoint, for example, as in a first card 70b illustrated in FIG. 8. In the example of FIG. 8, the answer is “ [symbol] ” (two kanji characters representing “Great Buddha”), which is derived by interpreting a kanji character and one or two katakana characters with similar shapes as equivalent characters, as appropriate, in the equation “ [symbol] ” (two kanji characters representing “carpenter”)+“ [symbol] ” (three katakana characters representing “lime”)−“ [symbol] ” (two katakana characters representing “gills”). In this example, the next checkpoint is Gifu Great Buddha, the first card 70s includes a photograph of Gifu Great Buddha as a representative image, and the answer to the quiz of the first card 70b is “ [symbol] ” (two kanji characters representing “Great Buddha”).

In the first card 70b, the approximate location of the next checkpoint is indicated by a circular frame on a map around the next checkpoint, as a further hint regarding the place. In addition, the first card 70b indicates a QR code or a web address in preparation for a case where the participant cannot derive the answer to the quiz and cannot grasp the next checkpoint even from the hint regarding the place. The QR code or the web address is information indicating a web site that presents information indicating a simpler hint, the answer, or the next checkpoint itself. Alternatively, when the information processing system 1 uses a chatbot of a message service or the like, the indicated QR code or web address may be information indicating link information, an input character string, and the like for the chatbot. The input character string is a character string that triggers a hint or the answer. Thus, the participant can know the hint or the answer from a response to the input character string on the chatbot.

In step S12, a first card is preferably also generated for checkpoints subsequent to the checkpoint as the first relay point, and stored at least until the first card is output.

Through the processing as described above, the participant is prepared to participate in the tour event along the sightseeing route. Next, processing at the start of the tour event is performed. To be specific, the participant logs in to the server apparatus 10 with the above-described ID using the portable terminal 40, and then reads a QR code to acquire information indicated by the QR code or acquires location information of a GNSS at the starting point (step S21). The QR code is printed in step S5, and is written on printed matter attached to the corresponding checkpoint by the registrant or the like. For example, each QR code can be attached to a location where the printer 30 is installed at the corresponding checkpoint. In addition, the QR codes themselves may include information for guiding the participant to log in to the server apparatus 10.

Then, the portable terminal 40 transmits the acquired information to the server apparatus 10 (step S22). Upon receiving the information indicated by the QR code or the location information from the portable terminal 40, the server apparatus 10 determines whether the participant is at the starting point on the basis of the received information (step S23). When the participant is at the starting point, the server apparatus 10 confirms that the participant is at the starting point, that is, the participant has arrived at the starting point. In this way, the starting point can also be treated as a type of checkpoint.

When the server apparatus 10 confirms the arrival of the participant by the location information of the GNSS, the server apparatus 10 preferably transmits guidance on the place where the printer 30 is installed at the checkpoint to the portable terminal 40 after the confirmation. As a result, the portable terminal 40 can display the place where the printer 30 is installed on an application program or a web browser to guide the participant. The description here assumes that the printer 30 installed at the starting point is the printer 30a.

After confirming the arrival of the participant at the starting point, the server apparatus 10 transmits a print instruction to print the cards generated for the starting point in step S12 to the printer 30a (step S24). The printer 30a, which has received the print instruction, executes printing of the cards (step S25). The cards printed in step S25 at the starting point are the cards generated in step S12, and include a third card and a first card. In each of step S12 and step S25, which is a step for the starting point, only a first card may be generated and output, and the participant can proceed to the next relay point with the first card.

The cards printed at the starting point may be one sheet of printed matter, but may be two or more sheets of printed matter. For example, the third card 60s illustrated in FIG. 6 can be printed as one sheet of printed matter, and the first cards 70s and 70b illustrated in FIGS. 7 and 8 can be printed on the front and back sides of one card. Further, the first cards 70s and 70b may be printed as separate cards. In addition, the content indicated by the third card 60s can be printed so as to be included in any one of the first cards 70s and 70b, thereby allowing the content indicated by the third card 60s, the first card 70s, and the first card 70b to be provided to the participant as one sheet of double-sided printed matter.

In steps S24 and S25, the output destination of the cards is the printer 30a, but the output destination may be the portable terminal 40, which is the transmission source of target point arrival information. In this case as well, the cards may be output as a plurality of pages of one electronic file, or may be output as a plurality of electronic files, as in the case where the cards are output as printed matter. Further, the output destination of the cards may be both the printer 30a and the portable terminal 40.

The participant heads toward the next checkpoint while checking the cards output as described above. Next, processing at the time of arrival at a checkpoint will be described for the next relay point following the starting point and the subsequent relay points. Also in this case, the same processing as the processing described in steps S21 to S25 is basically executed, and the cards printed or transmitted as a result include information as a first card related to the next checkpoint next following the processing target point. It is to be noted that the cards printed or transmitted at a checkpoint as a relay point do not need to include information as a third card.

For example, at a certain checkpoint, the server apparatus 10 confirms the arrival of the participant on the basis of the read QR code or the acquired location information of the GNSS. When the arrival of the participant is confirmed, the server apparatus 10 prints one sheet of printed matter in which a first card 90s illustrated in FIG. 9 is printed on the front side and a first card 90b illustrated in FIG. 10 is printed on the back side, and the participant can obtain the printed matter. Similarly to the first card 70s, the first card 90s includes a representative image and a description of the next checkpoint following the checkpoint at which the printing is executed, but may include a representative image and a description of the checkpoint at which the printing is executed instead with a meaning as a reward for arrival. Similarly to the first card 70b, the first card 90b includes a quiz, a hint, and other information regarding the above next checkpoint. The first cards 90b and 90s may be printed as two sheets of printed matter or may be output to the portable terminal 40 as one or two electronic files.

At the checkpoint as the relay point as well, similarly to the starting point, when the server apparatus 10 confirms the arrival of the participant by the location information of the GNSS, the server apparatus 10 may transmit guidance to the portable terminal 40 after the confirmation. Here, the guidance refers to guidance on the place where the printer 30 is installed at the checkpoint.

The participant repeats heading toward the next checkpoint while checking the cards as described above, and heads toward the final checkpoint near the destination point. Next, processing when the participant arrives at the final checkpoint will be described. As described above, the final checkpoint can be set at, for example, an entrance or a guidance center of the facility where a local image of the destination point is captured. In the case of the sightseeing route illustrated in FIG. 5, the final checkpoint refers to a checkpoint set near a goal G, and may be, for example, a fifth checkpoint.

For the final checkpoint as well, the same processing as the processing at the time of arrival at the checkpoints as the next relay point following the starting point and the subsequent relay points basically can be executed. That is, also in this case, the same processing as the processing described in steps S21 to S25 is basically executed. However, the cards printed or transmitted as a result preferably include information as a first card related to the destination point, which is the next checkpoint following the processing target point, and information as a fourth card.

To be specific, as in step S21, the participant reads a QR code at the final checkpoint to acquire information indicated by the QR code or acquires location information of the GNSS using the portable terminal 40 (step S31). This QR code is printed in step S5, and is written on printed matter attached to the final checkpoint by the registrant or the like.

Then, as in step S22, the portable terminal 40 transmits the acquired information to the server apparatus 10 (step S32). Upon receiving the information indicated by the QR code or the location information from the portable terminal 40, the server apparatus 10 determines whether the participant has arrived at a predetermined area near the destination point, that is, the final checkpoint, on the basis of the received information (step S33). When the participant is at the final checkpoint, the server apparatus 10 confirms that the participant has arrived at the final checkpoint.

After confirming the arrival of the participant at the final checkpoint, the server apparatus 10 transmits the cards generated for the final checkpoint in step S12 to the portable terminal 40, and causes the portable terminal 40 to display the cards (step S34). The cards transmitted in step S34 can include a fourth card and a first card as one or more electronic files.

The fourth card is a card including a local image of the destination point similarly to the third card. However, unlike the third card, the fourth card is output when the participant has reached the predetermined area, and thus is provided to the participant as a final guidance card when the tour event is about to end.

The first card includes a representative image of the destination point as the next checkpoint or a representative image of the final checkpoint. Since the final checkpoint is in the predetermined area near the destination point, the representative image of the final checkpoint eventually indicates the same image as the representative image of the destination point. Further, the first card includes guidance information on the destination point such as information on a quiz, a hint, a QR code, or the like.

The first card includes guidance information on the destination point that needs to be provided to the participant. Thus, when the local image of the destination point has been provided at the starting point, the card including the information of only the first card may be output in step S34.

Although the output destination of the cards is the portable terminal 40 in step S34, the output destination of the cards may be the printer 30b. In this case, similarly to the other checkpoints, at the final checkpoint, when the server apparatus 10 confirms the arrival of the participant by the location information of the GNSS, the server apparatus 10 may transmit guidance to the portable terminal 40 after the confirmation. For example, when the printer 30 installed at the final checkpoint is the printer 30b, the server apparatus 10 preferably transmits guidance on the printer 30b to the portable terminal 40. In addition, the output destination of the cards in step S34 may be both the printer 30b and the portable terminal 40.

In step S34, the server apparatus 10 may output guidance information such as a quiz or a hint for going to the place of the local image on a web browser or an application program, instead of outputting these pieces of information as a card. Alternatively, the distance from the current location to the place of the local image may be calculated on a map to present information indicating the distance, direction, or the like instead of providing guidance information via a card, a web browser, or an application program.

Next, when the participant searches for the location of the local image of the destination point and arrives at the destination point, the participant performs, on the portable terminal 40, an operation of taking a photograph using the portable terminal 40 so as to have the same composition at the location indicated by the local image. In accordance with this operation, the portable terminal 40 captures a photograph having the same composition at the location indicated by the local image using the imaging unit 46, and stores the captured image 42b in the storage unit 42 (step S35). Then, the portable terminal 40 transmits the captured image 42b to the server apparatus 10 (step S36).

The server apparatus 10, which has received the captured image 42b, determines the degree of similarity between the captured image 42b and the local image, thereby determining whether the participant has arrived at the destination point, that is, whether the participant has cleared the game event (step S37). That is, the destination point arrival information can include the captured image 42b obtained by the participant capturing the locally-acquired image shown in the local image of the destination point.

The determination in step S37 may be determination of whether the location information of the GNSS included in the captured image or the location information of the GNSS of the portable terminal 40 acquired separately from the captured image indicates a location within a predetermined range from the location indicated by the photography location information of the local image. Alternatively, the arrival of the participant may be determined on the basis of the information of a QR code, as in the case where the participant arrives at a checkpoint other than the destination point, which is the goal.

When it is determined that the participant has arrived at the destination point, the server apparatus 10 registers the captured image 42b received from the portable terminal 40 by storing the captured image 42b in the storage unit 12. As described above, the server apparatus 10 can be configured to, when the input processor 11a inputs a captured image obtained by the participant capturing the locally-acquired image shown in the local image of the destination point, store the captured image in the storage unit 12. Note that the above-described capturing of the locally-acquired image means capturing a subject corresponding to the local image of the destination point.

After confirming the arrival of the participant at the destination point, the server apparatus 10 generates a second card (step S38). The second card is preferably generated to print, for example, one sheet of printed matter including a second card 110s illustrated in FIG. 11 on the front side and a second card 110b illustrated in FIG. 12 on the back side. As a matter of course, the second card 110s and the second card 110b may be generated to be printed as two sheets of printed matter, or may be generated to be output to the portable terminal 40 as one or two electronic files.

The second card 110s can include the captured image 42b of the photograph taken by the participant and the name and description of the place. The second card 110b can include, for example, a route traveled by the participant, a starting point arrival time at which the sightseeing was started, a game clear time at which the sightseeing was finished, and an item which can be freely changed and input by the participant. This item can be, for example, the name of a favorite place among the visited checkpoints, a photograph of a purchase, an impression of the event, and the like. That is, the second card may include information from the participant that is input for output or another purpose by the input processor 11a. In addition, the second card 110b may include map information indicating a detailed map including the sightseeing route, or information for each checkpoint such as a time of arrival at each checkpoint and a staying time, or may include a QR code to a web page where these pieces of information can be confirmed, or the like.

As part of the information is exemplified in the second card 110b, the second card may include at least one of the following pieces of information. That is, the pieces of information include route information indicating a route traveled by the participant along the sightseeing route, time information indicating a time at which the participant started sightseeing along the sightseeing route, and time information indicating a time at which the participant arrived at a relay point. In addition, the pieces of information include time information indicating a time at which the participant departed from the relay point, time information indicating a time at which the participant arrived at the destination point, and time information indicating a period of time required from the start of sightseeing along the sightseeing route to the arrival at the destination point.

When the degree of similarity between the local image and the captured image 42b is determined in the determination of the arrival at the destination point, the degree of similarity may be included as the degree of matching in the second card 110s or the second card 110b. As a matter of course, also when the degree of similarity is not determined, the degree of similarity can be similarly calculated and included in the second card. In this way, the second card may include information indicating the degree of matching between the local image and the captured image 42b. This information can be included in the second card regardless of whether the second card includes the captured image 42b.

After the process of step S38, the server apparatus 10 transmits a print instruction to print the generated second card to the printer 30b or another printer 30 installed near the destination point (step S39). The printer 30b or the other printer 30, which has received the print instruction, executes printing of the second card (step S40). As a result, the participant can receive the second card as a final reward for the tour event in which the participant has participated. In addition, in steps S39 and S40, the output destination of the cards is the printer 30, but the output destination may be the portable terminal 40 or both of them.

In the above-described example, the server apparatus 10 outputs the first card to the output destination upon receiving the input of target point arrival information from the portable terminal 40 of the participant via the communication unit 13. However, the first card output at each checkpoint is not limited to being output at such an output timing. For example, all checkpoints that the participant needs to visit may be presented to the participant immediately after the start of the event, and a hint regarding the destination may be given at each checkpoint.

The server apparatus 10 may receive designation of the number of hints from the participant. At this time, when the registrant sets five hints regarding the destination point, the five hints may be presented at five checkpoints, respectively, and when the participant visits six or more checkpoints, an answer such as a QR code of a web page in which an answer, not a hint, is described, may be presented. For example, in the case of an answer for a destination point, detailed guidance on a location at which a local image of the destination can be captured can be presented to the participant as the answer.

The server apparatus 10 may allow the participant to register a candidate for a local image. Specifically, the captured image 42b captured in step S35 by a participant who previously participated is preferably used in a tour event of a participant who participates later. In addition, a captured image captured by the participant at a checkpoint as a relay point can also be used in the tour event of the participant who participates later by allowing the captured image to be separately registered in the server apparatus 10. When registering a candidate for a local image, the participant preferably registers contents which serve as a hint regarding the place where the local image was captured, such as the name, location information, and surrounding features of the place, or the like. Then, the registrant preferably can view the candidate and set the candidate as the local image.

As described above, the server apparatus 10 may include an updating unit that updates a local image registered as the sightseeing point information 12a to the captured image 42b obtained by the participant capturing the locally-acquired image shown in the local image. The updating unit can be exemplified by, for example, the communication unit 13, the input processor 11a, and the storage unit 12. To be specific, when the captured image 42b is received from the portable terminal 40 via the communication unit 13, the input processor 11a updates the sightseeing point information 12a so as to replace the corresponding local image in the sightseeing point information 12a of the storage unit 12 with the captured image 42b. As a matter of course, it is also possible to newly generate and add local image information from the received captured image 42b.

Not only the captured image 42b captured at the destination point but also a captured image captured by another person, such as the registrant, can be registered as a local image. That is, the server apparatus 10 may include an updating unit that updates a local image to a new image showing a locally-acquired image shown in the local image or an image showing a locally-acquired image, different from the locally-acquired image, at a sightseeing point. Although not illustrated, the updating unit can be exemplified by, for example, the communication unit 13, the input processor 11a, and the storage unit 12.

The participant may be allowed to register not only a candidate for a local image but also a candidate for a representative image. Accordingly, cards such as a first card can also include a captured image previously captured by the participant or another participant as the representative image. That is, the server apparatus 10 may allow a photograph taken by the participant to be placed in a portion where the representative image is placed. In addition, before a first card is output, the participant may register a captured image by operating the portable terminal 40, and the server apparatus 10 may generate and output the first card including the captured image. Moreover, the server apparatus 10 preferably receives the update of not only the local but also the representative image from the registrant.

As described with respect to each checkpoint, the target point arrival information indicating the arrival of the participant at the processing target point and the destination point arrival information indicating the arrival of the participant at the destination point may be location information indicating the location of the portable terminal 40 of the participant acquired at the arrival point. In this case, the output destination of a card includes the printer 30 installed at the point at which the card is output. Then, when it is confirmed by the location information that the participant has arrived at the point before the card is output to the printer 30, the server apparatus 10 preferably outputs guidance information indicating guidance on the point to the portable terminal 40 of the participant.

### Effects of the Present Embodiment

As described above, the information processing system 1 outputs a first card related to the next sightseeing point along the sightseeing route determined based on the designation information from the participant, upon receiving point information at the starting point or the relay point from the participant. Further, the information processing system 1 outputs a second card including, for example, a local image of the destination point upon receiving point information at the destination point from the participant.

In describing the effects, a system according to a comparative example will be described. The system according to the comparative example relates to a tour event that involves an event such as a riddle solution, and is a system in which the selection of a sightseeing route as in the present embodiment is not performed. In the system according to the comparative example, a tour event is conducted from predetermined content, which causes the participant to lose interest, creating a problem in holding continuous tour events.

On the other hand, in the information processing system 1, since a sightseeing route of a tour is not selected from sightseeing routes that are predetermined tour routes, it is unlikely that a similar sightseeing route is selected for a participant who participates more than once, causing the participant to lose interest in participating. Therefore, in the present embodiment, the participant can be expected to participate as a repeater, and as a result, tour events can be continuously held.

In the information processing system 1, since the cards are provided to the participant according to the sightseeing route as described above, the participant can obtain a unique card set for each held event. Therefore, also from this point of view, it can be said that, in the information processing system 1, the participant is less likely to lose interest even when participating more than once, and events can be continuously held.

In the information processing system 1, when designation information is received from the participant or point information at the starting point is received, a third card including a local image of the destination point can also be output. In addition, in the information processing system 1, when point information at the predetermined area near the destination point is received from the participant, a fourth card including a local image of the destination point can also be output. The provision of such an additional type of card can further promote the participant to participate in the next tour event. In addition, in the information processing system 1, since a local image can be updated to a captured image captured by the participant or the registrant, it is possible to further suppress the participant's loss of interest and to promote the participant to participate in the next tour event.

### Information Processing Method and Non-Transitory Computer-Readable Storage Medium Storing Program According to the Present Embodiment

The configuration of the information processing system has been mainly described as the present embodiment. The present disclosure can provide an information processing method as described in the information processing example. In addition, the present disclosure can provide a non-transitory computer-readable storage medium storing a program for causing a computer to execute information processing as in the information processing example, as mainly described for the program in the server apparatus 10.

The information processing method is a method in which a computer such as the server apparatus 10 executes information processing including each process described as being performed by the input processor 11a, the determination unit 11b, and the output processor 11c.

Additionally, the information processing includes a process of storing a representative image and a local image for each of a plurality of sightseeing points, a process of inputting information including designation information indicating a destination point of sightseeing designated by a participant of sightseeing from the plurality of sightseeing points, and an output process.

The output process is a process of determining a sightseeing route of the participant and outputting a card related to a point included in the sightseeing route to an output destination. More specifically, the output process includes a determination process of determining a relay point based on the destination point designated by the designation information, and determining a sightseeing route based on the destination point and the relay point. In addition, in the output process, when point information indicating the arrival of the participant at the processing target point, which is any one of the starting point and the relay point of the sightseeing route, is input, a first card is output to the output destination as the card. Further, in the output process, when point information indicating the arrival of the participant at the destination point is input, a second card related to the destination point is output to the output destination as the card. The first card and the second card are as described above.

Although other application examples will not be described, various application examples exemplified in the information processing system 1 can also be applied to the information processing described herein. In addition, the program that can be provided by the present disclosure includes a program for causing a computer to execute the information processing described herein.

### Other Modifications

The present disclosure is not limited to the above-described embodiment, and can be appropriately modified without departing from the scope of the present disclosure. For example, the configuration, the processing procedure, or the like of each apparatus, terminal, or printer exemplified in the information processing system 1 is not limited to those exemplified, and may be any configuration, processing procedure, or the like, as long as the functions thereof can be achieved.

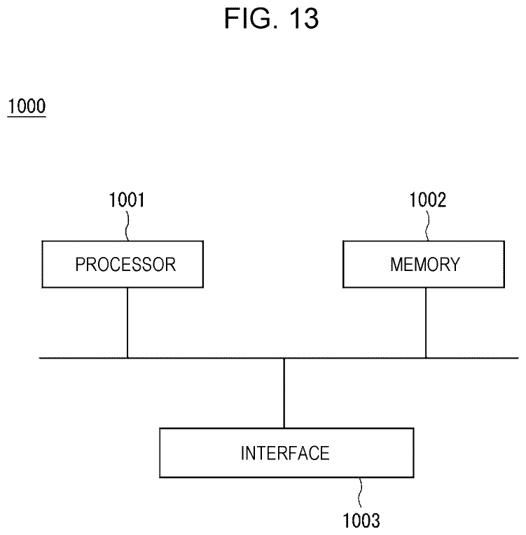

In addition, each apparatus, terminal, or printer, such as the server apparatus, the registrant terminal, the printer, and the portable terminal, according to the above-described embodiment can include, for example, the following hardware configuration. FIG. 13 is a diagram illustrating an example of the hardware configuration of an apparatus.

An apparatus 1000 illustrated in FIG. 13 can include a processor 1001, a memory 1002, and an interface 1003. The interface 1003 can include, for example, a communication interface and an interface with an input/output device or the like, which are necessary depending on the apparatus.

The processor 1001 may be, for example, a CPU, a GPU, a microprocessor unit (MPU) also referred to as a microprocessor, or the like. The processor 1001 may include a plurality of processors. The memory 1002 is configured by, for example, a combination of a volatile memory and a nonvolatile memory. The functions of each apparatus, terminal, or printer are implemented by the processor 1001 reading a program stored in the memory 1002 and executing the program while exchanging necessary information via the interface 1003.

In addition, the above-described program includes an instruction group (or software code) for causing a computer to perform one or more of the functions described in the embodiment when the program is read by the computer. The program may be stored in a non-transitory computer-readable medium or tangible storage medium. By way of example, and not limitation, examples of the computer-readable medium or the tangible storage medium include a random-access memory (RAM), a read-only memory (ROM), a flash memory, a solid-state drive (SSD), or other memory technologies. Also by way of example, and not limitation, examples of the computer-readable medium or the tangible storage medium include a CD-ROM, a digital versatile disc (DVD), a Blu-ray (registered trademark) disc, other optical disc storage, a magnetic cassette, magnetic tape, magnetic disk storage, and another magnetic storage device. The program may be transmitted on a transitory computer-readable medium or a communication medium. By way of example, and not limitation, the transitory computer-readable medium or communication medium includes an electrical, optical, acoustical, or other forms of propagated signals. Furthermore, the program is included in a program product.

Although the present disclosure has been described with reference to the above-described embodiment, the present disclosure is not limited to the configurations described in the above-described embodiment, and it goes without saying that the present disclosure includes various modifications, corrections, and combinations that can be made by those skilled in the art within the scope of the claims of the present application.

What is claimed is:

1. An information processing system comprising:
a storage unit configured to store a representative image and a local image for each of a plurality of tour points, the representative image being a representatively-acquired image showing a corresponding tour point of the plurality of tour points, the local image showing a locally-acquired image at the corresponding tour point of the plurality of tour points;
an input unit configured to input information including designation information indicating a destination point of a tour of the plurality of tour points, the destination point being designated by a participant of the tour; and
a control unit configured to determine a tour route of the participant and output a card related to a point included in the tour route to an output destination,
wherein the control unit is further configured to:
determine a relay point based on the destination point designated by the designation information;
determine the tour route based on the destination point and the relay point;
when the input unit inputs point information indicating arrival of the participant at a processing target point, output, as the card, a first card related to a next tour point following the processing target point along the tour route to an output destination, the processing target point being any one of a starting point and the relay point of the tour route, the first card including the representative image of the processing target point or the representative image of the next tour point; and
when the input unit inputs point information indicating arrival of the participant at the destination point, output, as the card, a second card related to the destination point to an output destination.

2. The information processing system according to claim 1, wherein
the control unit is further configured to, when the input unit inputs the designation information, or when the input unit inputs point information indicating arrival of the participant at a predetermined area near the destination point, output, as the card, a third card including the local image of the destination point to an output destination.

3. The information processing system according to claim 1, wherein
the control unit is further configured to, when the input unit inputs a captured image obtained by the participant capturing the locally-acquired image shown in the local image of the destination point, store the captured image in the storage unit.

4. The information processing system according to claim 3, wherein
the second card includes information indicating a degree of matching between the local image and the captured image.

5. The information processing system according to claim 3, wherein
the second card includes the captured image.

6. The information processing system according to claim 1, wherein
the point information indicating the arrival at the destination point includes a captured image obtained by the participant capturing the locally-acquired image shown in the local image of the destination point.

7. The information processing system according to claim 1, wherein
the first card includes information indicating a quiz regarding the next tour point.

8. The information processing system according to claim 1, further comprising:
a setting unit configured to set a tour point, of the plurality of tour points, which is to be excluded from a designation target for the destination point or a determination target for the relay point.

9. The information processing system according to claim 1, wherein
the point information indicating the arrival of the participant at the processing target point and the point information indicating the arrival of the participant at the destination point are information obtained by capturing and reading point identification information using a portable terminal of the participant, or location information indicating a location of the portable terminal of the participant, the point identification information being presented at the processing target point and the destination point, the location information being acquired at the processing target point and the destination point.

10. The information processing system according to claim 1, wherein
the point information indicating the arrival of the participant at the processing target point and the point information indicating the arrival of the participant at the destination point are location information indicating a location of a portable terminal of the participant, the location information being acquired at the processing target point and the destination point,
the output destination of the card includes a printer installed at a point where the card is output, and
the control unit is further configured to output guidance information indicating guidance on a point to the portable terminal of the participant, when arrival of the participant at the point is confirmed by the location information before the card is output to the printer.

11. The information processing system according to claim 1, wherein
the control unit is further configured to output the card to at least one of a portable terminal of the participant and a printer installed at a point where the card is output.

12. The information processing system according to claim 1, wherein
the second card includes at least one of route information indicating a route traveled by the participant in accordance with the tour route, time information indicating a time at which the participant starts the tour along the tour route, time information indicating a time at which the participant arrives at the relay point, time information indicating a time at which the participant departs from the relay point, time information indicating a time at which the participant arrives at the destination point, and time information indicating a period of time required to arrive at the destination point after the participant starts the tour along the tour route.

13. The information processing system according to claim 1, wherein
the second card includes map information indicating a detailed map including the tour route.

14. The information processing system according to claim 1, wherein
the second card includes information from the participant input by the input unit.

15. The information processing system according to claim 1, wherein
the control unit is further configured to determine the relay point by selecting a plurality of relay candidate points based on the destination point designated by the designation information, and randomly selecting the relay point from the plurality of selected relay candidate points.

16. The information processing system according to claim 1, wherein
the designation information is information indicating, as the destination point, a destination point designated by the participant from the local images of the plurality of tour points.

17. The information processing system according to claim 1, further comprising:
an updating unit configured to update the local image to a new image showing the locally-acquired image shown in the local image or an image showing a locally-acquired image, different from the locally-acquired image, at the corresponding tour point of the plurality of tour points.

18. The information processing system according to claim 1, further comprising:
an updating unit configured to update the local image to a captured image obtained by the participant capturing the locally-acquired image shown in the local image.

19. An information processing method of information processing executed by a computer, the information processing comprising:
storing a representative image and a local image for each of a plurality of tour points, the representative image being a representatively-acquired image showing a corresponding tour point of the plurality of tour points, the local image showing a locally-acquired image at the corresponding tour point of the plurality of tour points;
inputting information including designation information indicating a destination point of a tour of the plurality of tour points, the destination point being designated by a participant of the tour; and
performing an output process of determining a tour route of the participant and outputting a card related to a point included in the tour route to an output destination,
wherein the output process includes:
determining a relay point based on the destination point designated by the designation information;
determining the tour route based on the destination point and the relay point;
when point information indicating arrival of the participant at a processing target point is input, outputting, as the card, a first card related to a next tour point following the processing target point along the tour route to an output destination, the processing target point being any one of a starting point and the relay point of the tour route, the first card including the representative image of the processing target point or the representative image of the next tour point; and
when point information indicating arrival of the participant at the destination point is input, outputting, as the card, a second card related to the destination point to an output destination.

20. A non-transitory computer-readable storage medium storing a program for causing a computer to execute information processing, the information processing comprising:
storing a representative image and a local image for each of a plurality of tour points, the representative image being a representatively-acquired image showing a corresponding tour point of the plurality of tour points, the local image showing a locally-acquired image at the corresponding tour point of the plurality of tour points;
inputting information including designation information indicating a destination point of a tour of the plurality of tour points, the destination point being designated by a participant of the tour; and
performing an output process of determining a tour route of the participant and outputting a card related to a point included in the tour route to an output destination,
wherein the output process includes:
determining a relay point based on the destination point designated by the designation information;
determining the tour route based on the destination point and the relay point;
when point information indicating arrival of the participant at a processing target point is input, outputting, as the card, a first card related to a next tour point following the processing target point along the tour route to an output destination, the processing target point being any one of a starting point and the relay point of the tour route, the first card including the representative image of the processing target point or the representative image of the next tour point; and
when point information indicating arrival of the participant at the destination point is input, outputting, as the card, a second card related to the destination point to an output destination.
